(19) United States
(12) Patent Application Publication
(10) Pub. No.: US 2015/0000886 A1
(43) Pub. Date: Jan. 1, 2015

(54) Apparatus for Heat Dissipation and a Method for Fabricating the Apparatus

(71) Applicant: NANYANG TECHNOLOGICAL UNIVERSITY, Singapore (SG)

(72) Inventor: Seri Lee, Singapore (SG)

(21) Appl. No.: 14/362,601

(22) PCT Filed: Dec. 7, 2012
(86) PCT No.: PCT/SG2012/000459

§ 371 Date: Jun. 3, 2014

Related U.S. Application Data
(60) Provisional application No. 61/568,937, filed on Dec. 9, 2011.

(51) Int. Cl. F28F 1/12; B23P 15/26

(52) U.S. Cl. CPC F28F 1/12; B23P 15/26
USPC 165/185; 29/890.03

(57) ABSTRACT

There is provided an apparatus for heat dissipation and a method for fabricating the apparatus for heat dissipation. The apparatus for heat dissipation is for either single or two phase heat exchange, depending on a construction of the apparatus. A channel of the apparatus is defined by the joined bent first ends of each of a plurality of fins of the apparatus.

### FIELD OF INVENTION

The present invention relates to an apparatus for heat dissipation and a method for fabricating the apparatus.

### BACKGROUND

Electronics and microelectronics components, such as, for example, integrated circuit devices, microprocessors, concentrated photovoltaic cells, high performance LEDs, IGBTs, power converters and the like are becoming better. Part of the reason for the improvement in the components is due to greater packing densities. However, correspondingly, amounts of heat generated from these components have also increased. Furthermore, a strong demand for smaller form factors for these components has led to a decrease in the size of these components even though the amount of heat energy that must be dissipated from these components is increasing. This has led to substantial advancements in heat dissipation technologies/designs in order to meet industry needs.

In current packaging techniques, heat sinks typically consist of a flat baseplate, which is mounted onto the heat generating component on one side to effectively cool off the component. The heat sink may also include an array of fins running perpendicular to the flat base plate on the other side. As the heat sink size increases to utilize the maximum volume available within a given form factor of a system, the heat sink experiences a greater temperature gradient from the hottest part of the heat sink at the center of the baseplate (in contact with a heat source) to peripheral edges of the baseplate/outer ends of the fins. As such, the temperatures of the peripheral edges of the baseplate/outer ends of the fins become substantially lower than that at the center of the baseplate. This drastically reduces the overall efficiency of the heat sink, when compared to an identical heat sink which maintains its temperature at a maximum temperature of the baseplate (in contact with the heat source) throughout the entire volume of the heat sink.

Early versions of heat sinks developed for electronics cooling were mostly made of aluminum (which has a moderately high thermal conductivity of approximately 200 W/mK) due to cost and weight benefits. Gradually, copper, with a thermal conductivity of around 400 W/mK, was commonly used in heat sink applications. Initially, the baseplate of a heat sink was typically made of copper while aluminum was still utilized for fins. Then the aluminum fins were replaced by copper fins, leading to the entire heat sink being made of copper. Copper heat sinks were expensive and heavy, and their effectiveness was questionable. Consequently, various types of heat spreaders were fabricated based on two-phase thermal transport mechanisms which provided improved effective thermal conductivities in the order of tens or even hundreds of thousands of W/mK. Examples of such spreaders, which utilize the phase change heat transfer for its high heat transfer coefficient and ability to convectively transport heat over a longer distance without increasing thermal resistance, include heatpipes, flat heatpipes (ie vapor chambers), vertical vapor chambers (ie vapor towers), thermosyphones, and so forth.

FIG. 1 shows an example of one such heat spreader. FIG. 1(a) illustrates heatpipes bent in various forms, FIG. 1(b) illustrates a cross-sectional view of a heatpipe showing a wick made of sintered copper powder, and FIG. 1(c) illustrates how a heatpipe works.

FIG. 2 shows another example of a heat spreader, namely heat sinks that utilize heatpipes. FIG. 2(a) illustrates heatpipes embedded in a heat sink baseplate, FIG. 2(b) illustrates heatpipes connecting the baseplate through the fins of a heat sink, and FIG. 2(c) illustrates heatpipes in tall high-performance heat sinks.

FIG. 3 shows yet another example of a heat spreader, namely flat heatpipes or vapor chambers used as baseplate of a heat sink. FIG. 3(a) shows one such example, and FIG. 3(b) illustrates how the flat vapor chambers work as a heat spreader in the baseplate.

FIG. 4 shows an example of a vapor chamber heat spreader. FIG. 4(a) shows an exploded view of a heat sink assembly which employs a thermosyphone vapor tower, FIG. 4(b) illustrates how the thermosyphone vapor chamber works while FIG. 4(c) illustrates a vapor tower heat sink used in a desktop computer. The thermosyphone vapor chamber illustrated in FIG. 4 is a hollow tube, sealed at both ends, consisting of an evaporator at the bottom portion of the chamber in contact with the heat source, condenser surface along the inside of the container which is in contact with externally attached cooling fins, and a vapor leading section along the hollow channel connecting the evaporator section and the condenser section of the chamber. It contains a choice of working fluid injected into the chamber during the fabrication process. When heat enters into the evaporator section, the liquid in the evaporator vaporizes and the vapor will flow through the vapor channel to the condenser. Along the condenser surface, the vapor will be condensed back into liquid, which will return to the evaporator by the gravitational force, completing the heat transport cycle. It should be noted that the temperature of the fluid throughout this phase-changing cycle is fixed at constant vapor temperature which depends only on the type of the working fluid and the internal operating pressure of the chamber. As such, it allows heat to be transported over a long distance without detriment on the resistance of the chamber.

FIG. 5 shows a schematic cross sectional view of a vapor chamber heat sink, where fins are attached to a central vapor chamber. In such a heat sink, there is heat spreading in a vertical direction similar to that described in relation to FIG. 4.

It should be appreciated that in the preceding examples, heat spreading occurs either laterally along the baseplate or vertically into the fin region.

### SUMMARY

In a first aspect, there is provided a method for fabricating an apparatus for heat dissipation. The method includes locating a plurality of fins adjacent to each other, a bent first end of each of the plurality of fins being in contact with at least one adjacent fin; and joining the plurality of fins to each other at the bent first ends of each of the plurality of fins. It is preferable that the joined bent first ends of each of the plurality of fins are configured to define a channel. Preferably, single phase heat exchange can take place with use of the channel.

The method may further include mounting a first end of the channel onto a base sheet metal heat spreader; and locating a cover at a second end of the channel, the cover being for sealing the second end of the channel. The cover can be soldered to the second end of the channel or alternatively, solder bits are positioned, then heated and cured at the cover. It is preferable that two phase heat exchange can take place with use of the sealed channel.

Each of the plurality of fins is made of a material such as, for example, aluminium, copper, plastics, copper-tungsten pseudoalloy, silicon carbide in aluminium matrix, diamond in copper-silver alloy matrix, beryllium oxide in beryllium matrix and so forth. Preferably, the bent first ends of each of the plurality of fins are joined to each other using processes such as, for example, soldering, brazing, applying adhesives, epoxy bonding and the like. Each of the bent first ends is at an angle of between 30° to 150° to the fin. It is preferable that a wall of the channel includes a jagged surface which is configured to either act as nucleate sites to enhance drop-wise condensation in two-phase applications or generate turbulent flow in single-phase applications.

In a second aspect, there is provided an apparatus for heat dissipation. The apparatus includes a plurality of fins joined together at bent first ends of each of the plurality of fins, whereby the joined bent first ends of each of the plurality of fins are configured to define a channel. It is preferable that single phase heat exchange can take place with use of the channel.

The apparatus can further include a base sheet metal heat spreader for mounting a first end of the channel; and a cover at a second end of the channel, the cover being for sealing the second end of the channel. The cover can be soldered to the second end of the channel or alternatively, solder bits are positioned, then heated and cured at the cover. It is preferable that two phase heat exchange can take place with use of the sealed channel.

Each of the plurality of fins is made of a material such as, for example, aluminium, copper, plastics, copper-tungsten pseudoalloy, silicon carbide in aluminium matrix, diamond in copper-silver alloy matrix, beryllium oxide in beryllium matrix and so forth. Preferably, the bent first ends of each of the plurality of fins are joined to each other using processes such as, for example, soldering, brazing, applying adhesives, epoxy bonding and the like. Each of the bent first ends is at an angle of between 30° to 150° to the fin. It is preferable that a wall of the channel includes a jagged surface which is configured to either act as nucleate sites to enhance drop-wise condensation in two-phase applications or to generate turbulent flow in single-phase applications.

### DESCRIPTION OF FIGURES

In order that the present invention may be fully understood and readily put into practical effect, there shall now be described by way of non-limitative example only preferred embodiments of the present invention, the description being with reference to the accompanying illustrative figures.

FIG. 1 shows a first example of related prior art.

FIG. 2 shows a second example of related prior art.

FIG. 3 shows a third example of related prior art.

FIG. 4 shows a fourth example of related prior art.

FIG. 5 shows a schematic cross sectional view of a vapor chamber heat sink (prior art).

FIG. 6 shows a schematic cross sectional view of a first embodiment of the present invention.

FIG. 7 shows an enlarged view of an inner surface of a channel of FIG. 6.

FIG. 8 shows schematic cross sectional views of variations of the embodiment of FIG. 6.

FIG. 9 shows possible profiles of a channel of FIG. 6.

FIG. 10 shows a schematic cross sectional view of a second embodiment of the present invention.

FIG. 11 shows an end view of the second embodiment of FIG. 10.

FIG. 12 shows schematic cross sectional views of variations of the embodiment of FIG. 10.

FIG. 13 shows a process flow for a preferred embodiment for a method of the present invention.

FIG. 14 shows a cross-sectional view of a fin as used in the present invention.

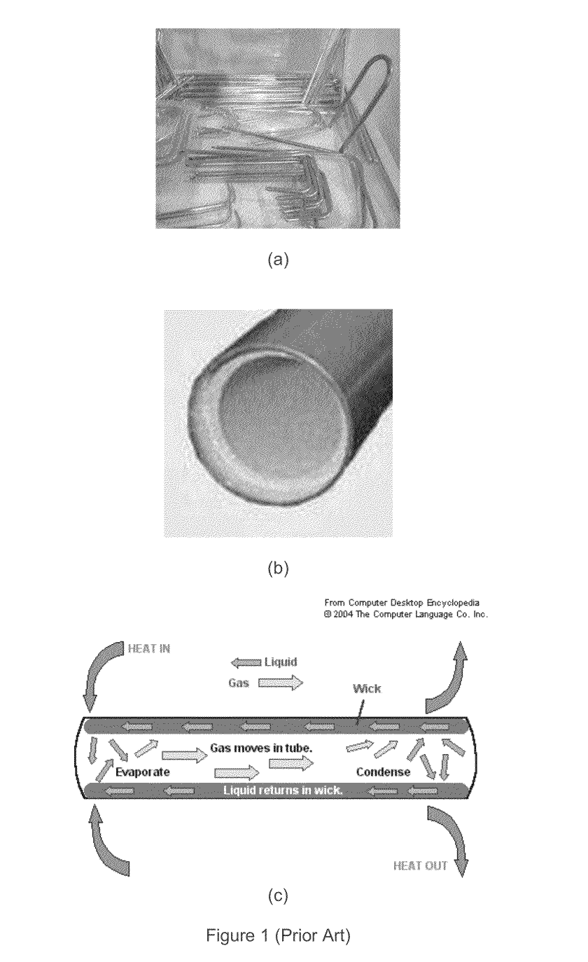

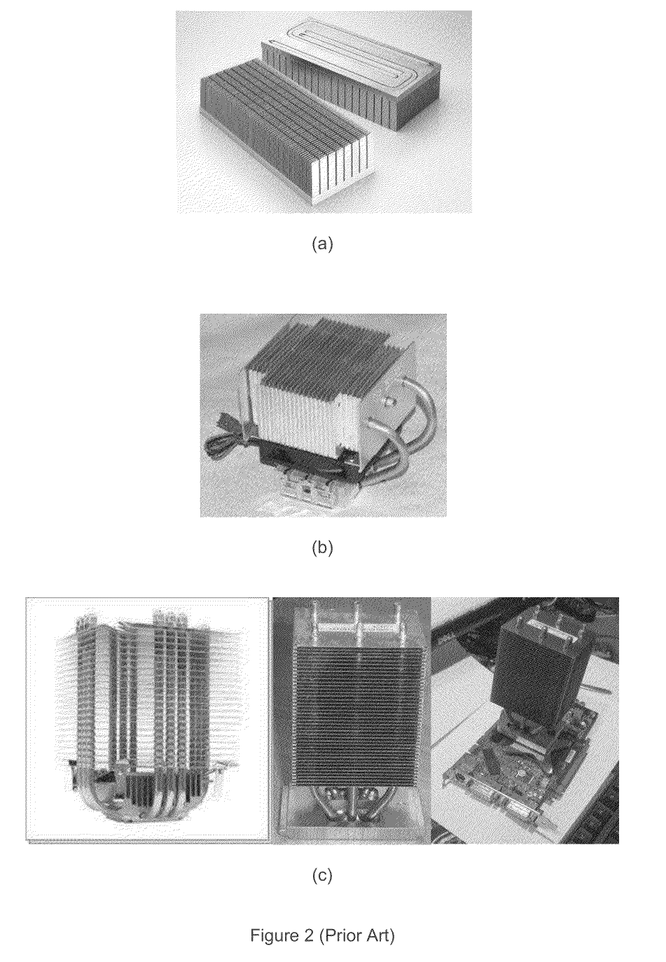

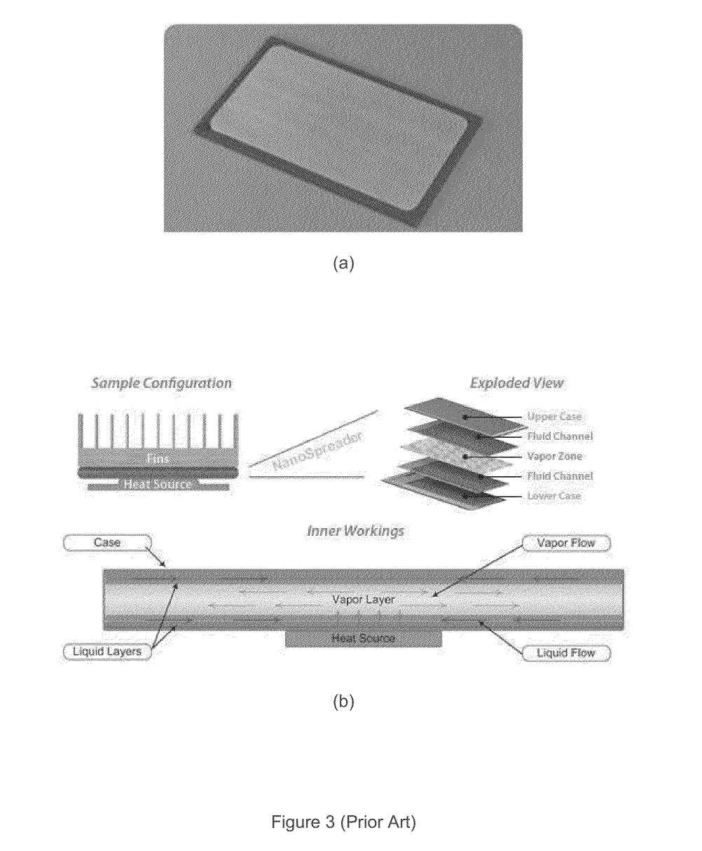

### DESCRIPTION OF PREFERRED EMBODIMENTS

The present invention relates to an apparatus for the dissipation of heat in a manner which enhances heat spreading characteristics, lowers a weight of the apparatus, enhances thermal performance of the apparatus, and lowers a cost of production of the apparatus. The apparatus is suitable for both single phase and double phase heat exchange. Details relating to how the aforementioned advantages are brought about will be provided in the following description. A method to fabricate the aforementioned apparatus is also provided.

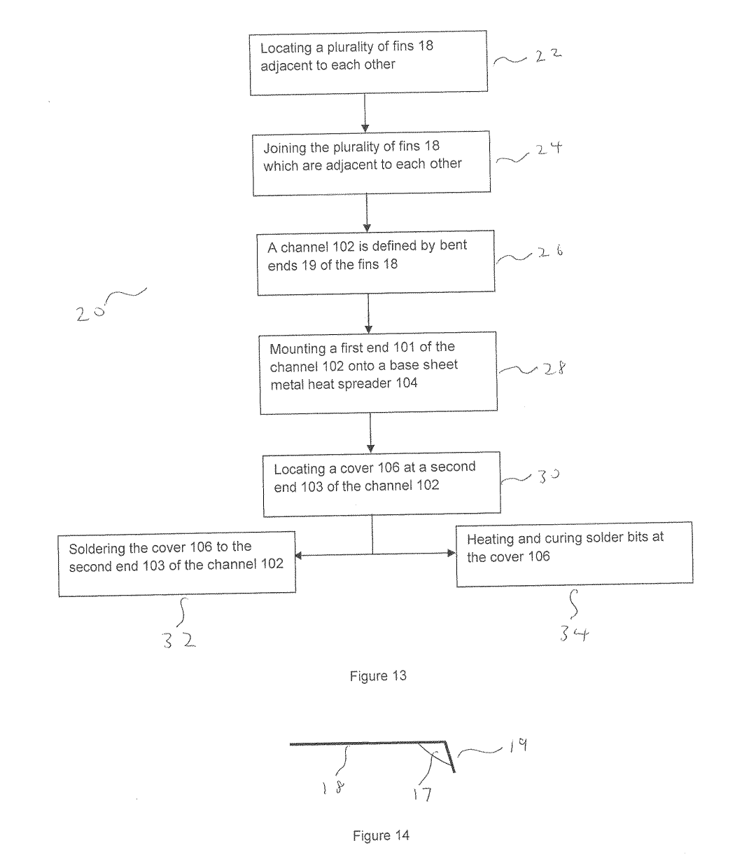

Referring to FIG. 13, there is shown a method 20 for fabricating an apparatus for the dissipation of heat, whereby the apparatus is suitable for both single phase and double phase heat exchange. The method 20 includes locating a plurality of fins 18 (as shown in FIG. 14) adjacent to each other (22). Each of the plurality of fins is made of materials such as, for example, aluminium, copper, plastics, copper-tungsten pseudo-alloy, silicon carbide in aluminium matrix, diamond in copper-silver alloy matrix, beryllium oxide in beryllium matrix and so forth. Each of the plurality of fins 18 includes a bent first end 19 and each of the plurality of fins 18 is in contact with at least one adjacent fin 18. Each of the bent first ends 19 is at an angle 17 of between 30° to 150° to the fin 18.

Then, the plurality of fins 18 are joined to each other at the bent first ends 19 of each of the plurality of fins 18 (24). The bent first ends 19 of each of the plurality of fins 18 are joined to each other using processes such as, for example, soldering, brazing, applying adhesives, epoxy bonding and the like. The joined bent first ends 19 of each of the plurality of fins 18 are configured to define a channel. Examples of a profile shape of the channel are shown in FIG. 9. An elliptical shape shown in FIG. 9 aids in reducing the airflow resistance across the fins and/or redirecting the direction of the airflow by acting as a louvre to upstream flow. A star shape is provided in FIG. 9 merely to highlight general and arbitrary possibilities of the profile and to illustrate how a shape may be designed in such a way that the internal convection heat transfer is increased which enhances an overall performance of a heat sink.

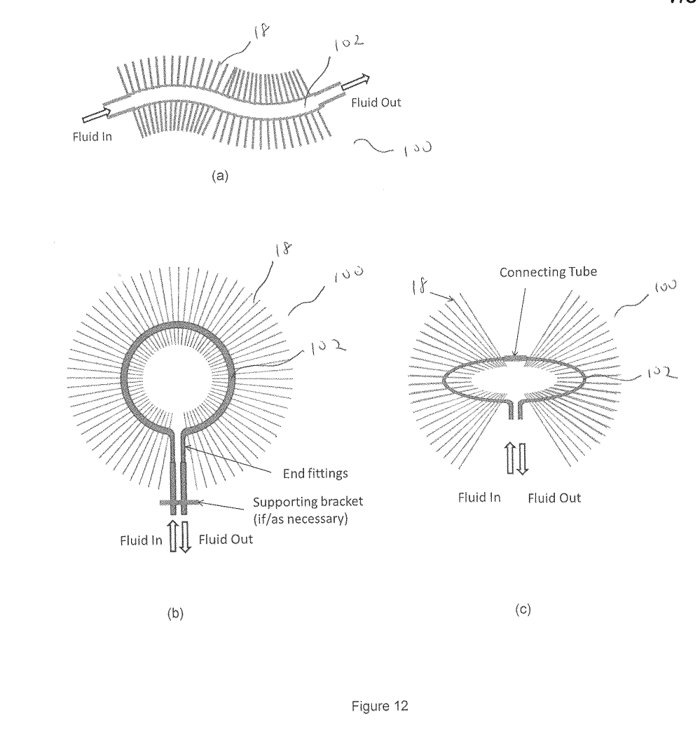

The exact angle 17 of the bent first end 19 of each of the plurality of fins depends on a cross-sectional shape of the channel. At this juncture, single phase heat exchange can take place with use of the channel. Examples include liquid-to-air or gas-to-gas heat exchangers. As such, an apparatus 100 can be fabricated in a first embodiment as shown in FIGS. 10 and 12, as single phase heat exchangers. It should be noted that a channel 102 of the 100 can be contoured and can meander in both a two-dimensional and a three-dimensional space. Referring to FIG. 7, a wall of the channel 102 defined by the joined bent first ends 19 of each of the plurality of fins 18 includes a jagged and/or roughened surface 16. The jagged and/or roughened surface 16 enhances internal heat transfer by acting as eddy current or turbulence generators.

The advantages of a single phase heat exchanger fabricated using such a method 20 include lower cost of fabrication since no inner tube/pipe is required, lower weight since no inner tube is required and better heat transfer performance since there is no core to fin contact resistance. The use of method 20 also enables a multiple number of channels 102 to be fabricated at minimal additional cost, for better performance and structural rigidity. This is illustrated using FIG. 11, whereby each fin 18 includes multiple openings 10, whereby a plurality of the fins 18 are stacked to form a desired heat exchanger.

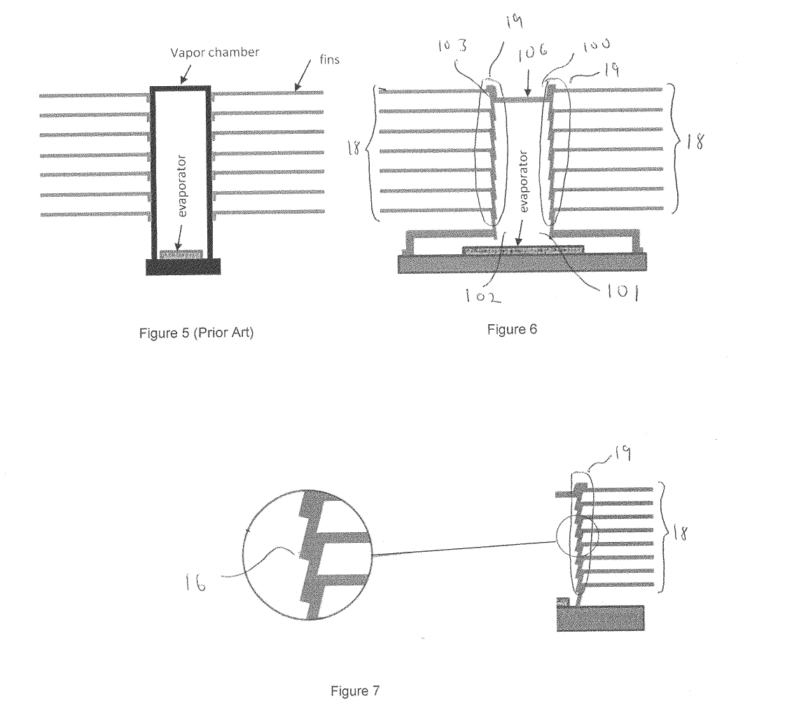

The method 20 also includes mounting a first end 101 of the channel 102 onto a base sheet metal heat spreader 104 (28). This is shown in FIG. 6, which shows a second embodiment of the apparatus 100, the second embodiment being a two phase heat exchanger. The first end 101 of the channel 102 is mounted onto the base sheet metal heat spreader 104. The mounting of the channel 102 is carried out using processes such as, for example, soldering, brazing, applying adhesives, epoxy bonding and the like. Then, a cover 106 is located at a second end 103 of the channel 102 (30), the cover 106 being for sealing the second end 103 of the channel 102. The cover 106 may be either soldered to the second end 103 of the channel 102 (32) or undergo heating and curing such that solder bits positioned at the cover 106 will hold the cover 106 in position at the second end 103 of the channel 102 (34).

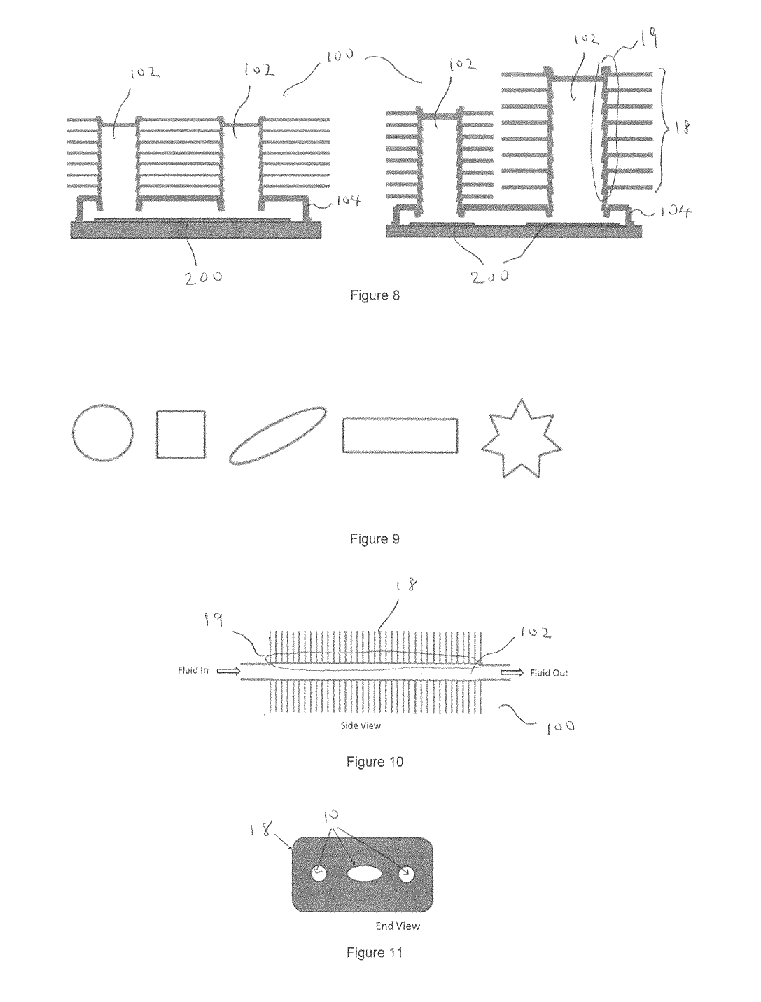

When the apparatus 100 is used as a two phase heat exchanger, the jagged and/or roughened surface 16 of the channel 102 enhances drop-wise condensation. The jagged and/or roughened surface 16 (formed by cascading the bent first ends 19 of each of the plurality of fins 18) either acts as nucleate sites to enhance drop-wise condensation in two-phase applications by avoiding filming of condensed liquid or generates turbulent flow in single-phase applications. The jagged surface 16 provides a greater heat transfer coefficient than a film-wise condensation which would occur over a smooth surface such as an inner surface of a separate vapor chamber. Furthermore, the jagged surface 16 can be further machined/modified to induce dripping of condensed droplets. In FIGS. 6 and 8, the sealed channel 102 behaves like a vapor chamber. It should be noted that FIG. 8 shows a multiple fin assembly of the apparatus 100 with differing fin heights and fin counts which is able to accommodate different airflow conditions and pressure drop requirements over the respective fin-zones. FIG. 8 also shows use of evaporators 200 of different sizes and positionings.

The advantages of a two phase heat exchanger fabricated using such a method 20 include shorter fabrication time due to removal of physical chamber core (leading to a lesser parts count), lower fabrication cost due to shorter fabrication time and the lesser parts count, lower weight due to the lesser parts count, design flexibility including being able to incorporate a base heat spreader and having multiple fin assemblies, and enhanced thermal performance compared to conventional vapor chambers. The enhanced thermal performance relates to design flexibility for the evaporator 200, lateral heat spreading in the base spreader 104, jagged channel surface which promotes drop-wise condensation and elimination of the interface/contact resistance between the vapor chamber and fins (as shown in FIG. 5).

Referring to FIGS. 6, 8, 10, and 12, there is shown various embodiments of an apparatus 100 for heat dissipation. The apparatus 100 include a plurality of fins 18 joined together at bent first ends 19 of each of the plurality of fins, wherein the joined bent first ends 19 of each of the plurality of fins are configured to define a channel 102. Each of the plurality of fins is made of materials such as, for example, aluminium, copper plastics, copper-tungsten pseudo-alloy, silicon carbide in aluminium matrix, diamond in copper-silver alloy matrix, beryllium oxide in beryllium matrix and so forth. Each of the plurality of fins 18 includes a bent first end 19 and each of the plurality of fins 18 is in contact with at least one adjacent fin 18. Each of the bent first ends 19 is at an angle 17 of between 30° to 150° to the fin 18.

The apparatus 100 in a first embodiment as shown in FIGS. 10 and 12 is a single phase heat exchanger. Examples include liquid-to-air or gas-to-gas heat exchangers. It should be noted that a channel 102 of the apparatus 100 can be contoured and can meander in both a two-dimensional and a three-dimensional space. Referring to FIG. 7, a wall of the channel 102 defined by the joined bent first ends 19 of each of the plurality of fins 18 includes a jagged surface 16. Examples of a profile shape of the channel are shown in FIG. 9. An elliptical shape shown in FIG. 9 aids in reducing the airflow resistance across the fins and/or redirecting the direction of the airflow by acting as a louvre to upstream flow. A star shape is provided in FIG. 9 merely to highlight general and arbitrary possibilities of the profile and to illustrate how a shape may be designed in such a way that the internal convection heat transfer is increased which enhances an overall performance of a heat sink.

The advantages of a single-phase heat exchanger according to a first embodiment of the apparatus 100 include lower cost of fabrication since no inner tube/pipe is required, lower weight since no inner tube is required and better heat transfer performance since there is no core to fin contact resistance. The apparatus 100 also allows a multiple number of channels 102 to be fabricated at minimal additional cost, for better performance and structural rigidity. This is illustrated using FIG. 11, whereby each fin 18 includes multiple openings 10, whereby a plurality of the fins 18 are stacked to form a desired heat exchanger.

In a second embodiment of the apparatus 100 as shown in FIGS. 6 and 8 where the apparatus 100 is a two phase heat exchanger, the apparatus 100 also includes a base sheet metal heat spreader 104 for mounting a first end 101 of the channel 102. The mounting of the channel 102 is carried out using processes such as, for example, soldering, brazing, applying adhesives, epoxy bonding and the like. The apparatus 100 also includes a cover 106 at a second end 103 of the channel 102, the cover 106 being for sealing the second end 103 of the channel 102. The cover 106 may be either soldered to the second end 103 of the channel 102 or undergo heating and curing such that solder bits positioned at the cover 106 will hold the cover 106 in position at the second end 103 of the channel 102.

When the apparatus 100 is used as a two phase heat exchanger, the jagged and/or roughened surface 16 of the channel 102 enhances drop-wise condensation. The jagged and/or roughened surface 16 (formed by cascading the bent first ends 19 of each of the plurality of fins 18) either acts as nucleate sites to enhance drop-wise condensation in two-phase applications by avoiding filming of condensed liquid or generates turbulent flow in single-phase applications. The jagged surface 16 provides a greater heat transfer coefficient than a film-wise condensation which would occur over a smooth surface such as an inner surface of a separate vapor chamber. Furthermore, the jagged surface 16 can be further machined/modified to induce dripping of condensed droplets. In FIGS. 6 and 8, the sealed channel 102 behaves like a vapor chamber. It should be noted that FIG. 8 shows a multiple fin assembly of the apparatus 100 with differing fin heights and fin counts which is able to accommodate different airflow conditions and pressure drop requirements over the respective fin-zones. FIG. 8 also shows use of evaporators 200 of different sizes and positionings.

The advantages of a two phase heat exchanger according to a second embodiment of the apparatus 100 include shorter fabrication time due to removal of physical chamber core (leading to a lesser parts count), lower fabrication cost due to shorter fabrication time and the lesser parts count, lower weight due to the lesser parts count, design flexibility including being able to incorporate a base heat spreader and having multiple fin assemblies, and enhanced thermal performance compared to conventional vapor chambers. The enhanced thermal performance relates to design flexibility for the evaporator 200, lateral heat spreading in the base spreader 104, jagged channel surface which promotes drop-wise condensation and elimination of the interface/contact resistance between the vapor chamber and fins (as shown in FIG. 5).

In addition to the opportunities for reducing the manufacturing cost and the weight of the apparatus for heat dissipation as described in the preceding sections, elimination of the vapor tower also provides an opportunity to improve the thermal performance of the two phase heat sink by reducing or removing the thermal resistance of the following:
contact resistance between the vapor tower and the fins;
conduction resistance through the thickness of the vapor tower; and
condensation resistance over the inner surface of the vapor tower by promoting “dropwise” condensation rather than “film-wise” condensation.

Estimation of Thermal Performance Improvements

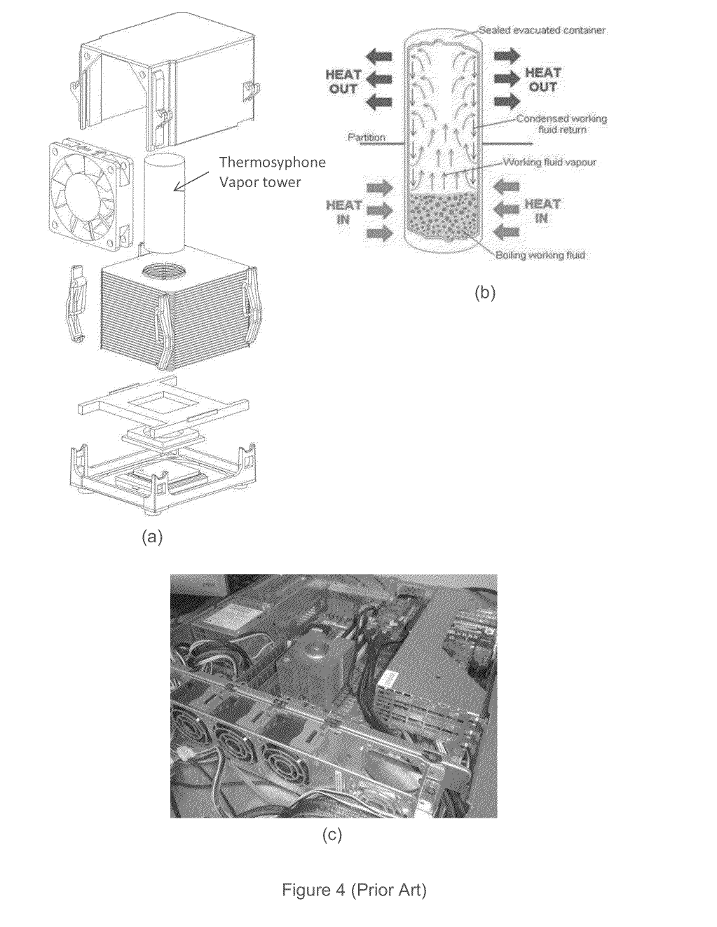

By taking a case example of a typical vapor chamber heat sink, similar to the one shown in FIG. 4, an estimation of the magnitude of the thermal performance improvement in the aforementioned components listed above will now be provided. The case example will assume a heat sink size of approximately 90 mm×100 mm×70 mm (width×length×height), which conforms to a typical desktop heat sink size. The total heat sink resistance of a high-performance two-phase vapor tower heat sink of this size is approximately 0.22 K/W. The core copper vapor tower has dimensions of approximately 25 mm diameter×75 mm tall×1.6 mm thick.

Contact Resistance

The contact resistance, R_{contact}, can be estimated by using the following correlation equation developed by M. M. Yovanovich:

$${R}_{contact} = \frac{σ / m}{1.25 {A}_{c} {{k}_{s} ( P / H )}^{0.95}}$$

whereby,

kₛ=2k₁K₂/(k₁+k₂) (harmonic mean solid conductivity of two mating materials)

σ=√σ₁²+σ₂² (combined RMS roughness)

m=√m₁²+m₂² (combined RMS roughness slope)

P (contact pressure)

H (hardness of the softer solid)

A_{c} (contact area)

with

k₁=386 W/mK for copper core

k₁=170 W/mK for aluminum fins

H=H₂=1180×10⁶ Pa (softer material)

Assuming typical surface roughness and the roughness to slope ratios assumed as, σ₁=σ₂×0.64 μm and σ₁/m₁=σ₂/m₂=7 μm and the contact pressure of 1.38×10⁶ Pa (˜200 psi) and contact area of 0.001 m² (approximately 20% of an outer surface area of the core in close contact with the fin-stock), it follows that:

kₛ=2k₁k₂/(k₁+k₂)=236 W/mK

σ=√σ₁²+σ₂²=0.91×10⁻⁶ m

P/H=1.38/1180=1.17×10⁻³

Hence, substitution of the above corresponding values into the correlation equation of Yovanovich results in:

$${R}_{contact} = \frac{7 \times {10}^{- 6}}{1.25 \times 0.005 \times 236 \times {( 1.17 \times {10}^{- 3} )}^{0.95}} = 0.0029 K \text{/} W$$

This represents approximately 7% of the total heat sink resistance of 0.22 K/W.

Conduction Resistance

The conduction resistance, R_{conduction}, can be determined by using the following expression:

$${R}_{conduction} = \frac{ln {d}_{o} / {d}_{i}}{2 π kl}$$

where, dₒ, dⱼ: outer and inner diameters of copper core, respectively, in m
k: thermal conductivity of copper=386 W/mK
l: length of copper core in m

Hence, using the corresponding values,

$${R}_{conduction} = \frac{ln 0.025 / 0.0218}{2 π \times 386 \times 0.075} = 0.0008 K \text{/} W$$

This represents less than 1% of the total heat sink resistance. As such, this improvement can and will be considered negligible.

Condensation Resistance

The film-wise and drop-wise condensation resistances, R_{condensation}_{_{—}}_{film} and R_{condensation}_{_{—}}_{drop}, can be determined by using the expressions given in Chapter 10.6 of “Heat and Mass Transfer—Fundamentals and Applications” by Cengel and Ghajar, 4^{th} Ed. McGraw Hill:

$${R}_{condensation\_film} = \frac{1.80}{{A [ \frac{g {ρ}_{l} {Δρ}_{lv} {k}_{l}^{3}}{{μ}_{l} Δ {T}_{sat} d} ( {h}_{fg} + \frac{3}{8} {c}_{pl} Δ {T}_{sat} ) ]}^{1 / 4}}$$

$${R}_{condensation\_drop} = \frac{1}{A ( 51104 + 2044 {T}_{sat} )}$$

where
A: condensation surface area ˜0.005 m²
g: gravity=9.8 m/s²
d: inner diameter of the core=0.0218 m
Δρᵢᵥ: difference between liquid and vapor densities=ρₗ−ρᵥ˜ρₜ=985 kg/m³
Tₛₐₜ: difference in saturation and surface temperatures=5° C. (assumed)
ρₗ: density of liquid=985 kg/m³
kₗ: thermal conductivity of liquid=0.65 W/mK
μₗ: dynamic viscosity of liquid=0.504×10⁻³ kg/m·s
Cₚₗ: specific heat of liquid=4183 J/kg·K
h_{fg}: enthalpy of vaporization=2370 kJ/kg
Tₛₐₜ: saturation temperature (at Pₛₐₜ˜16 kPa)=55° C.

Substituting the values, we get:

$${R}_{condensation\_film} = \frac{1.80}{0.005 \times {[ \frac{9.8 \times 985 \times 985 \times {0.65}^{3}}{0.504 \times {10}^{- 3} \times 5 \times 0.0218} ( 2370 \times {10}^{3} + \frac{3}{8} 4183 \times 5 ) ]}^{\frac{1}{4}}} = 0.0196 K \text{/} W$$

$${R}_{condensation\_drop} = \frac{1}{0.005 \times ( 51104 + 2044 \times 55 )} = 0.00122 K \text{/} W$$

Hence, the improvement opportunity is the difference between the above two resistances, or 0.0184 K/W, representing 8% of the total heat sink resistance.

However, since it is not likely for a vapor tower to experience pure filmwise condensation during operation (typically mixed with drop-wise condensation), the expected improvement should be downgraded perhaps by a factor of 2 as a correction factor. So, a 4% improvement in condensation is a more reasonable figure.

In conclusion, based on the above estimations, a heat sink which incorporates the present invention is likely to have an improvement of at least 10% in relation to thermal performance.

Whilst there has been described in the foregoing description preferred embodiments of the present invention, it will be understood by those skilled in the technology concerned that many variations or modifications in details of design or construction may be made without departing from the present invention.

1. A method for fabricating an apparatus for heat dissipation, the method including:
locating a plurality of fins adjacent to each other, a bent first end of each of the plurality of fins being in contact with at least one adjacent fin; and
joining the plurality of fins to each other at the bent first ends of each of the plurality of fins,
wherein the joined bent first ends of each of the plurality of fins are configured to define a channel.

2. The method of claim 1, wherein single phase heat exchange can take place with use of the channel.

3. The method of either claim 1, further including:
mounting a first end of the channel onto a base sheet metal heat spreader; and
locating a cover at a second end of the channel, the cover being for sealing the second end of the channel.

4. The method of claim 3, further including soldering the cover to the second end of the channel.

5. The method of claim 3, further including:
positioning solder bits at the cover; and
heating and curing the solder bits at the cover.

6. The method of claim 3, wherein two phase heat exchange can take place with use of the channel.

7. The method of claim 1, wherein each of the plurality of fins is made of a material selected from a group consisting of: aluminium, copper, plastics, copper-tungsten pseudo-alloy, silicon carbide in aluminium matrix, diamond in copper-silver alloy matrix, and beryllium oxide in beryllium matrix.

8. The method of claim 1, wherein the bent first ends of each of the plurality of fins are joined to each other using processes selected from a group consisting of: soldering, brazing, applying adhesives, and epoxy bonding.

9. The method of claim 1, wherein each of the bent first ends is at an angle of between 30° to 150° to the fin.

10. The method of claim 1, wherein a wall of the channel includes a jagged surface which is configured to either act as nucleate sites to enhance drop-wise condensation or generate turbulent flow.

11. An apparatus for heat dissipation, the apparatus including a plurality of fins joined together at bent first ends of each of the plurality of fins, wherein the joined bent first ends of each of the plurality of fins are configured to define a channel.

12. The apparatus of claim 11, wherein single phase heat exchange can take place with use of the channel.

13. The apparatus of claim 11, further including:
a base sheet metal heat spreader for mounting a first end of the channel; and
a cover at a second end of the channel, the cover being for sealing the second end of the channel.

14. The apparatus of claim 13, wherein the cover undergoes either direct soldering to the second end of the channel or heating and curing of solder bits located at the cover.

15. The apparatus of claim 13, wherein two phase heat exchange can take place with use of the channel.

16. The apparatus of claim 11, wherein each of the plurality of fins is made of a material selected from a group consisting of: aluminium, copper, plastics, copper-tungsten pseudo-alloy, silicon carbide in aluminium matrix, diamond in copper-silver alloy matrix, and beryllium oxide in beryllium matrix.

17. The apparatus of claim 11, wherein each of the bent first ends is at an angle of between 30° to 150° to the fin.

18. The apparatus of claim 11, wherein a wall of the channel includes a jagged surface which is configured to either act as nucleate sites to enhance drop-wise condensation or generate turbulent flow.
